(19) United States
(12) Patent Application Publication
(10) Pub. No.: US 2007/0146803 A1
(43) Pub. Date: Jun. 28, 2007

(54) Information recording apparatus and recorded information management method

(75) Inventor: Takuji Kimura, Ome-shi (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 11/640,354

(22) Filed: Dec. 18, 2006

(30) Foreign Application Priority Data
Dec. 26, 2005 (JP) 2005-373574

(51) Int. Cl. H04N 1/00

(52) U.S. Cl. 358/403; 358/402

(57) ABSTRACT

According to one embodiment, an apparatus has a buffer unit, an input/output unit, a first image recording time storage unit which accumulates an image recording time length in units of recording, and then, calculates and stores an image recording time length for a single file, a second image recording time storage unit which calculates and stores a total image recording time length of a plurality of files, an image recording time length update processing unit which updates an image recording time length component in units of recording in addition to the image recording time length for the single file and the total image recording time length, and a recording control unit which records the image recording time length for the single file and the total image recording time length in the medium.

### CROSS-REFERENCE TO RELATED APPLICATIONS

This application is based upon and claims the benefit of priority from Japanese Patent Application No. 2005-373574, filed Dec. 26, 2005, the entire contents of which are incorporated herein by reference.

### BACKGROUND

1. Field

One embodiment of the present invention relates to an information recording apparatus and a recorded information management method that are effective in the case where a digital broadcast signal is stored in a memory medium such as an SD memory card (registered trademark), for example.

2. Description of the Related Art

In recent years, a digital camera for compressing mobile image data and storing the compressed data in a built-in memory or an SD memory card has been prevalent. In addition, a portable cellular phone capable of transmitting the compressed mobile image data via an e-mail has also been prevalent.

MPEG-2, MPEG-4 and the like are known as a system of compressing mobile image data/voice data. An apparatus for compressing and handling such mobile image data/voice data carries out a processing operation of multiplexing mobile image data and voice data, and finally storing and transferring the multiplexed data as a file. In order to handle this file, an MPEG-4 file format (hereinafter, referred to as MP4) is proposed as one of the MPEG-4 standards (see Jpn. Pat. Appln. KOKAI Publication No. 2005-65110).

On the other hand, an SD-Video standard (SDA) is proposed in an SD memory card for storing the file as described above. A field for storing an individual image recording time length of each recorded content file and a field for storing a total image recording time length of all content files in the SD memory card are defined in a management information file of such an SD-Video standard. In an image recording apparatus, there is a need for processing information to be described in these fields.

In the meantime, in the case where an attempt is made to record a broadcast program received by a broadcast receiver in real time in the SD memory card described above, the individual image recording time length of the content file to be stored in a management information file and the total image recording time length of all the content files are not determined until a program terminates. Therefore, in general, when a program terminates, and then the individual image recording time length of the content file and the total image recording time length of all the content files are determined, a design is made so as to update information contained in the management information file.

However, with this method, in the case where any error occurs, and as a result recording is interrupted in the course of image recording or in the case where recording is interrupted partway due to a failure (such as operation error, consumption of battery power supply, or power-down), the values of fields in which the above individual image recording time length and the total image recording time length are to be described remains undetermined.

Therefore, a management information file is not completed in a normal format, and a failure occurs with subsequent operations of creating/editing a play list, and further, reproducing recorded information.

### BRIEF DESCRIPTION OF THE SEVERAL VIEWS OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an illustrative view showing a root directory in an SD memory card used in an embodiment according to the present invention;

FIG. 2 is an illustrative view of a management file 11 for managing a content file recorded in the SD memory card;.

FIG. 3 is an illustrative view of a management data file 10 for managing the whole information recorded in the SD memory card;

FIG. 4 is an illustrative view of an MP4 file format;

FIG. 5 is an illustrative view of a format of an MPEG2TS file;

FIG. 6 is an illustrative view showing a relationship between a change progress and an image recording time (reproduction time) length, of a fragment unit (write unit) when compressed/encoded contents are recorded in an SD memory card in an apparatus according to an embodiment of the present invention;

FIG. 7 is a view showing a whole configuration of the apparatus according to en embodiment of the present invention;

FIGS. 8A and 8B are views respectively showing an example of a configuration of an MPEG4 recording/reproducing unit and a TS format recording/reproducing unit shown in FIG. 7;

FIG. 9 is a flow chart adapted to illustrate an operation of characterizing portions of the apparatus according to an embodiment of the present invention; and

FIG. 10 is a view showing a processing block that corresponds to the flow chart shown in FIG. 9.

### DETAILED DESCRIPTION

Various embodiments according to the invention will be described hereinafter with reference to the accompanying drawings.

In an embodiment according to the present embodiment, it is an object of the present invention to provide an information recording apparatus and a recorded information management method in which, even if a failure occurs during recording, already recorded contents are produced to be as correct a format data as possible at the time point of the failure.

According to one embodiment, an information recording apparatus has a first image recording time storage unit for a single file which, when compressed/encoded contents are delimited in units of recording, are sequentially recorded in a recording medium, and are formed as a single file, sequentially accumulates an image recording time length in the units of recording, and then, calculates and stores an image recording time length for a single file. In addition, the apparatus has a second image recording time storage unit which calculates and stores a total image recording time length of a plurality of files recorded in the recording medium. Further, the apparatus has: an image recording time length update processing unit which updates the recorded image recording time length component of the units of recording every time small contents that are the units of recording are recorded in the recording medium, in addition to the image recording time length for the single file and the total image recording time length; and a recording control unit which records in the recording medium, the image recording time length for the single file and the total image recording time length updated in each of the first and second image recording storage units every time the contents delimited in the units of recording have been recorded in the recording medium.

According to the embodiment described above, an image recording time length for a single file and a total image recording time length of a plurality of files are updated in units of recording in which contents are to be recorded in a recording medium instead of in units of programs or files. As a result, even if a failure occurs during recording, already recorded contents are produced as management information data in as correct a format as possible at the time point of the failure.

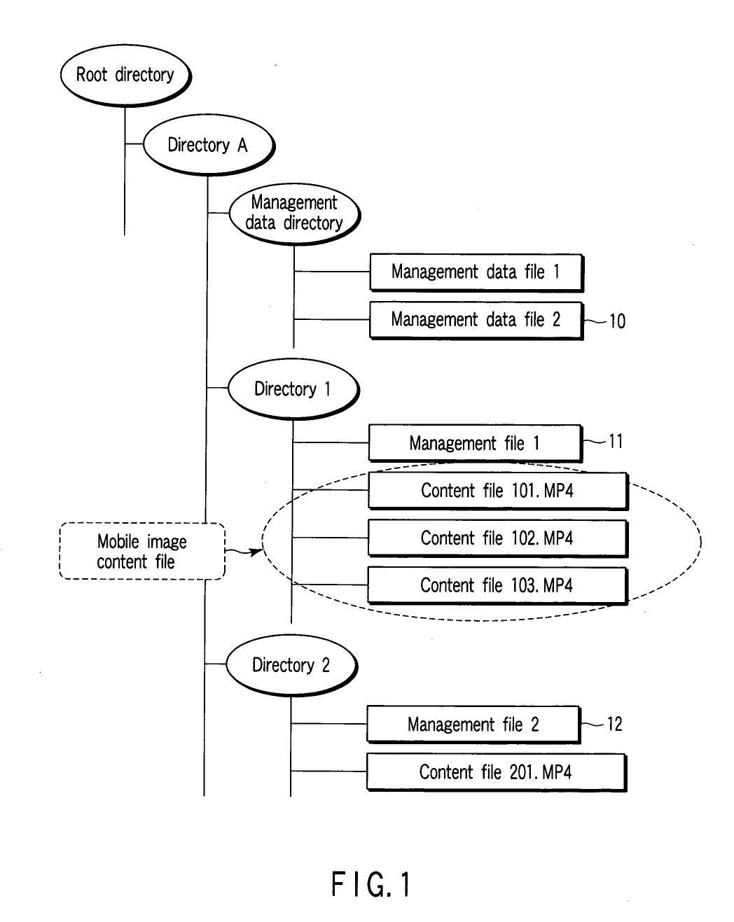

Now, an embodiment of the present invention will be described here with reference to the accompanying drawings. First, a recording format of an SD memory card will be described here. FIG. 1 shows a root directory. In the root directory, a management data file 10 for carrying out whole management is defined. Further, management files 11, 12 and the like for managing a content file exist. In the illustrative example, a content file 101.MP4, a content file 102.MP4, and a content file 103.MP4 are shown as mobile image content files under the control of the management file 11.

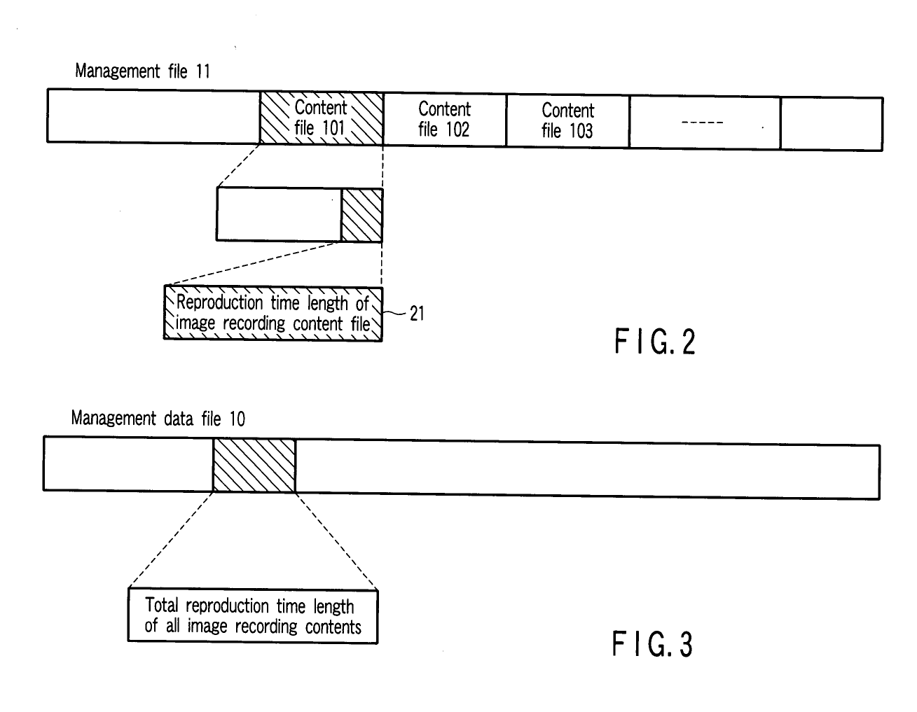

FIG. 2 shows how information contained in a plurality of content files is managed in the management file 11. In the figure, there is shown how recording areas of the content files 101, 102, and 103 are set. Further, a field 21 for describing a reproduction time length of each recorded content file is prepared in the management information contained in the content file 101. This reproduction time length is referred to as an individual reproduction time length (individual image recording time length or image recording time length for one file).

FIG. 3 shows a field 22 for describing a total reproduction time length of all recorded content files in the management data file 10. The total reproduction time length is defined as total of a plurality of reproduction time lengths for single files.

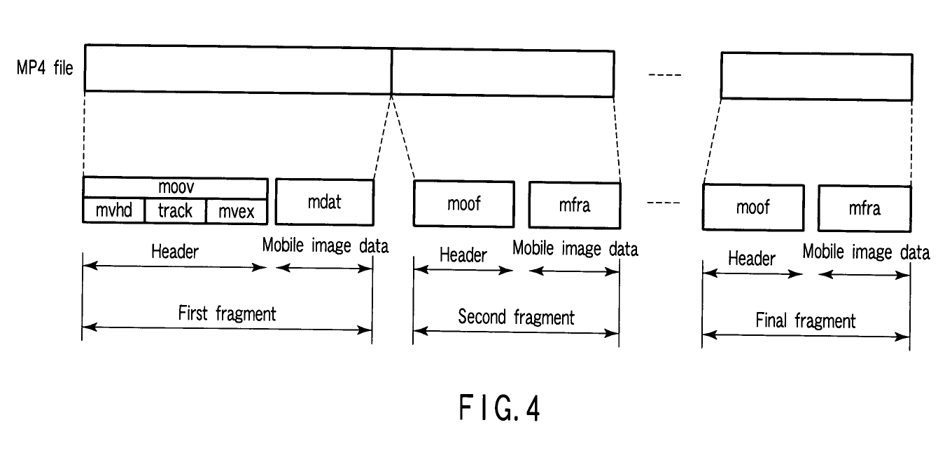

FIG. 4 shows a configuration of an MP4 file. Basically, a group of a header region and a mobile image data region is defined as one fragment. One fragment is a unit of recording. The identification information and compressed mobile image data and voice data are multiplexed in the mobile image data region. In addition, the identification information, information (such as sampling frequency information or attribute information) for decoding mobile image data and voice data, a data size and the like are described in the header region.

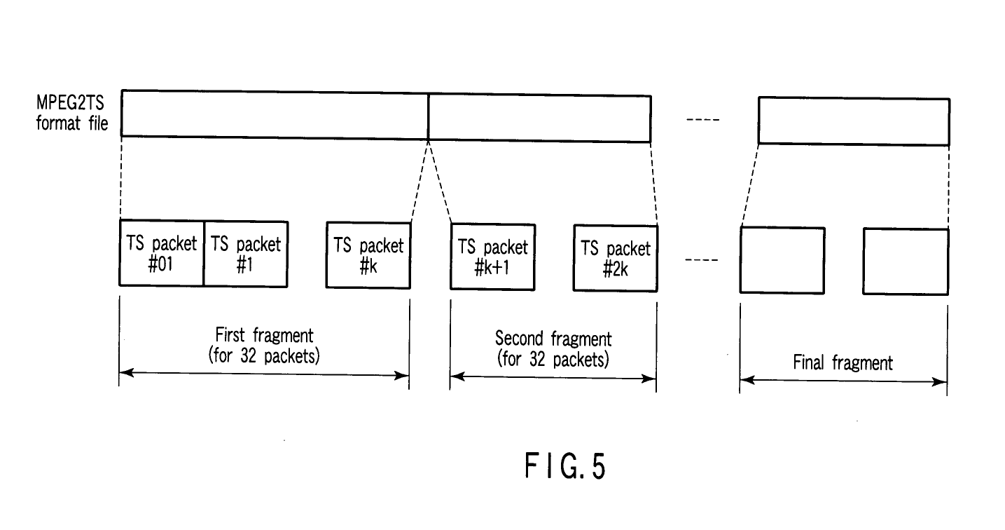

FIG. 5 shows an example of a recording format when a transport stream (TS) is recorded. In this recording format as well, a fragment is defined as a unit of recording. One fragment is defined as 32 packets. In the packets, contents such as image data or voice data are encoded, compressed, and stored in accordance with the MPEG2 standard.

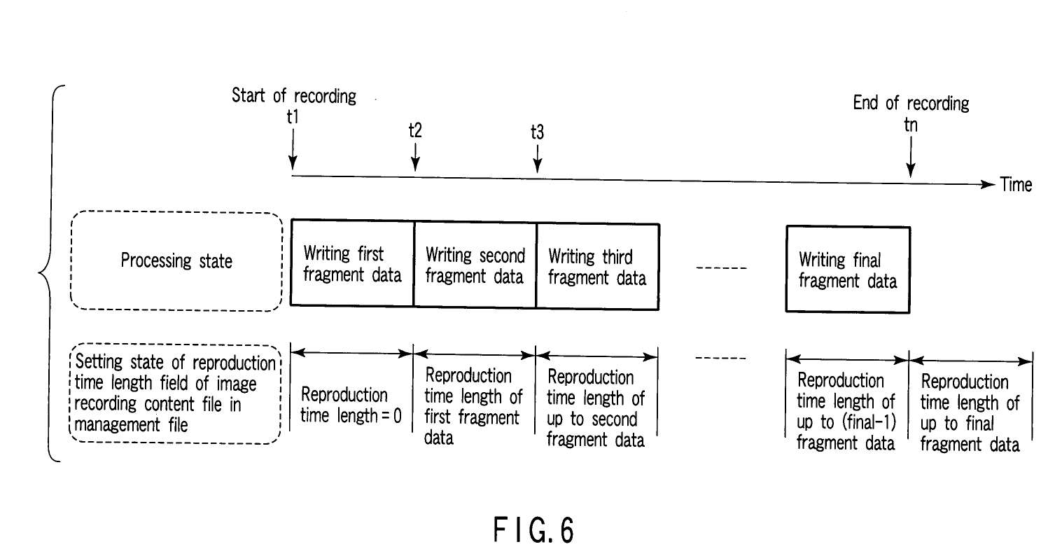

FIG. 6 shows how data is recorded in an SD memory card by the apparatus according to the present invention with an elapse of time. Recording is started (time point t1), and writing of first fragment data starts. At this time, a reproduction time length is 0. When writing of the first fragment data terminates, and then, writing of second fragment data is started (time point t2), storage of a reproduction time length of the first fragment data is carried out in a management file at this time. Next, when writing of the second fragment data terminates, and then, writing of third fragment data is started (time point t3), storage of a reproduction time length up to the second fragment data is carried out in the management file at this time.

Further, when writing of the third fragment data terminates, and then, writing of fourth fragment data is started, storage of a reproduction time length up to the third fragment data is carried out in the management file at this time. In this manner, update of the reproduction time length is sequentially carried out. At a time point tn at which recording has terminated, a reproduction time length up to final fragment data is managed as an individual reproduction time length.

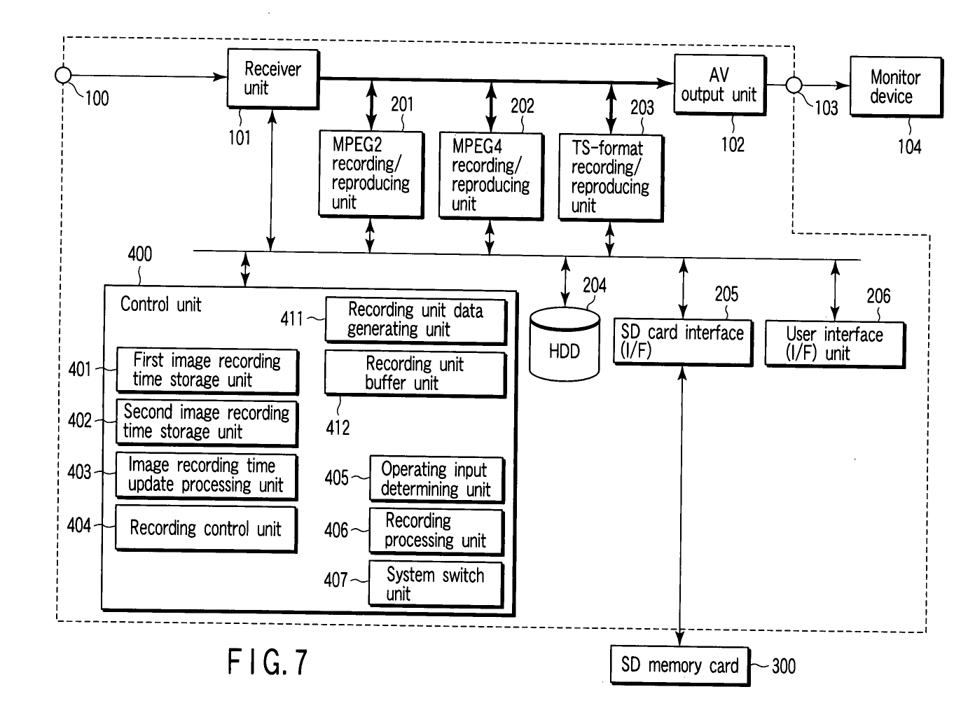

FIG. 7 shows an example of a configuration of a broadcast receiving apparatus to which the present invention has been applied, and particularly shows the portions associated with the present invention. A broadcast signal inputted from an input terminal 100 is inputted to a receiver unit 101, in which program data for a desired channel is demodulated. The demodulated program data is led out to an output terminal 103 via an AV output unit 102. Image data and voice data from the output terminal 103 are supplied to a monitor device 104, and then, the image and voice data are outputted as an image and a voice.

An output of the receiver unit 101 is inputted to an MPEG2 recording/reproducing unit 201 and an MPEG4 recording/reproducing unit 202. In addition, in the case where the output of the receiver unit 101 is a packet of transport streams, the output is inputted to a TS-format recording/reproducing unit 203. In the present invention, it is not always necessary that the MPEG2 recording/reproducing unit 201, the MPEG4 recording/reproducing unit 202, and the TS-format recording/reproducing unit 203 exist at the same time.

The recorded information processed by the MPEG2 recording/reproducing unit 201 and the MPEG4 recording/reproducing unit 202 is formatted so that it can be recorded as the MP4 file described previously. The formatted management information and contents are recorded in a recording medium. The recording mediums include a hard disk 204 or an SD card memory 300. The hard disk 204 is incorporated in the apparatus. The SD card memory 300 can be connected to an apparatus main body via an interface 205 or can be detached therefrom. Reference numeral 206 denotes a user interface unit that corresponds to a key input unit or a remote control signal receiver unit.

Reference numeral 400 denotes a control unit that includes a microprocessor, and integrally controls an operation of this apparatus. Here, the control unit 400 basically has: a first image recording time storage unit 401 for calculating and storing an individual image recording time length for a single file being processed (corresponding to an individual reproduction time length); and a second image recording time storage unit 402 for calculating and storing a total image recording time length for a plurality of files (corresponding to a total reproduction time length). In addition, this control unit has an image recording time length update processing unit 403 for, when compressed/encoded contents in a unit of recording has been outputted to a recording medium, updating an image recording time length component of a unit of recording in addition to the individual image recording time length and the total image recording time length. A recording control unit 404 outputs and controls compressed/encoded contents via an input/output unit 205 with respect to a recording medium (for example, SD memory card 300) in predetermined units of recording and controls recording information from the recording medium (for example, SD memory camera 300) to be captured in units of recording.

In addition, the control unit 400 controls a recording unit data generating unit 411 and a recording unit buffer unit 412. An interrelationship between these units will be described later in detail.

Furthermore, the control unit 400 has an operating input determining unit 405 and a recording processing unit 406. Moreover, this control unit has a system switch unit 407 for switching a processing system.

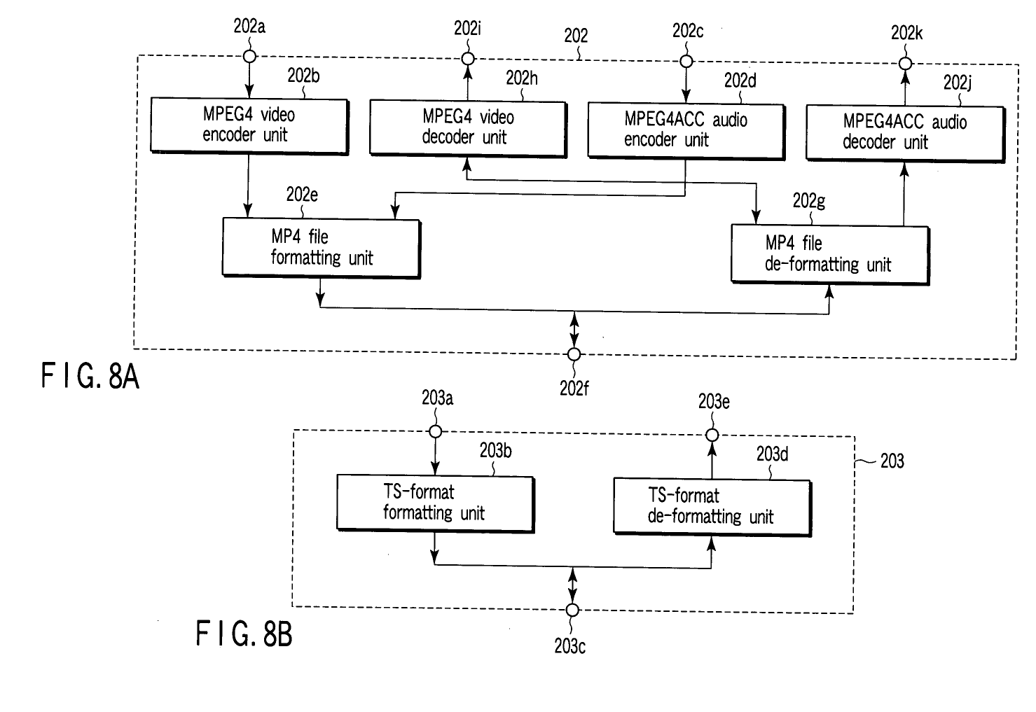

FIG. 8A further shows a functional block inside of the MPEG4 recording/reproducing unit 202 described above. In the MPEG4 recording/reproducing unit 202, input video data from an input unit 202a is encoded by means of a video encoder unit 202b which encodes data in accordance with the MPEG4 standard. In addition, the input audio data from an input unit 202c is encoded by means of an audio encoder unit 202d.

Outputs of the encoder units 202a and 202b are formatted as described in FIG. 4 in an MP4 file formatting unit 202e to be outputted to an input/output unit 202f in units of fragment. In addition, a PM4 file read out from a recording medium is de-formatted by means of an MP4 file de-formatting unit 202g, and compressed video data is decoded by means of a video decoder unit 202h to be outputted to an output terminal 202i. In addition, the compressed audio data de-formatted by means of the MP4 file de-formatting unit 202g is decoded by an audio decoder unit 202j to be led out to an output terminal 202k.

FIG. 8B shows a block configuration of a TS-format recording/reproducing unit 203. A packet of TS streams introduced into the input terminal 203a is formatted as described in FIG. 5 in a TS-format formatting unit 203b. Then, the packet is supplied to a recording medium via an input/output unit 203c in units of fragments. In addition, data contained in units of fragments read out from a recording medium is introduced into a TS de-formatting unit 203d via the input/output unit 203c, in which the data is de-formatted. The de-formatted TS is supplied to a packet processing unit (not shown) via an output unit 203e.

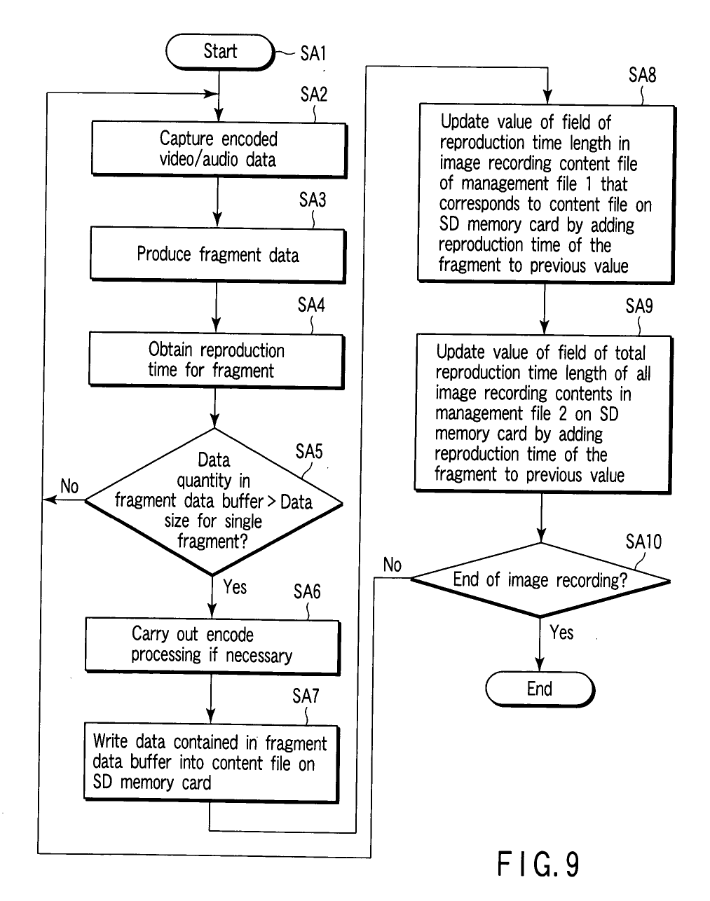

FIG. 9 shows a characterizing operation of the apparatus according to the present embodiment by way of flow chart. When processing starts, the capturing of encoded video/audio data (buffer capturing) is carried out (steps SA1 and SA2). A buffer is provided at an output stage of each recording/reproducing unit. Next, generation of fragment data as described in FIGS. 4 and 5 is executed (step SA3). In addition, a reproduction time for fragments (image recording time) is obtained (step SA4). This time is obtained by counting a time of video data for a base-band to be handled, for example, by means of a counter.

Next, it is determined whether or not a data quantity contained in a fragment data buffer becomes larger than a data size for a single fragment (step SA5). In the case where the data quantity is less than the data size for a single fragment, processing reverts to step SA2. In the case where it has been found, in step SA5, that a data quantity in the fragment data buffer is larger than the data size for a single fragment, a encoding process is carried out if necessary (step SA6), and then, writing process to an SD memory card is carried out (step SA7).

Next, as described in FIG. 6, update of an individual reproduction time (image recording time) length is carried out (step SA8). Furthermore, update of a total reproduction time (total image recording time) length is carried out (step SA9). Next, it is determined whether or not the image recording has terminated (step SA10). In the case where the determination result is negative, processing reverts to step SA2. In the case where the determination result is affirmative, processing terminates. In the above processing operation, it is a matter of course that the following processing operations are executed before starting operation. That is, a total image recording time length before updated, that has been already recorded, is transferred in advance from the inside of a management data file of the SD memory card 300 to the second image recording time storage unit 402 for calculating and storing a total image recording time length for a plurality of files, before starting a calculating operation.

In a file conforming to the transport stream (TS) described in FIG. 5, one fragment is defined as 32 packets, an image recording time length for each fragment in units of recording has been accumulated, and an individual image recording time length has been obtained. However, without being limited to such a method, an image recording time length may be measured in units of encoding, the units of encoding may be defined as units of recording, and an individual image recording time length for one file may be obtained by cumulatively adding the image recording time length in units of encoding.

In addition, in the case where file dividing occurs according to copy control information (CCI), image recording time information at a time point of such dividing is set in a management data file as a tentative value at that time point.

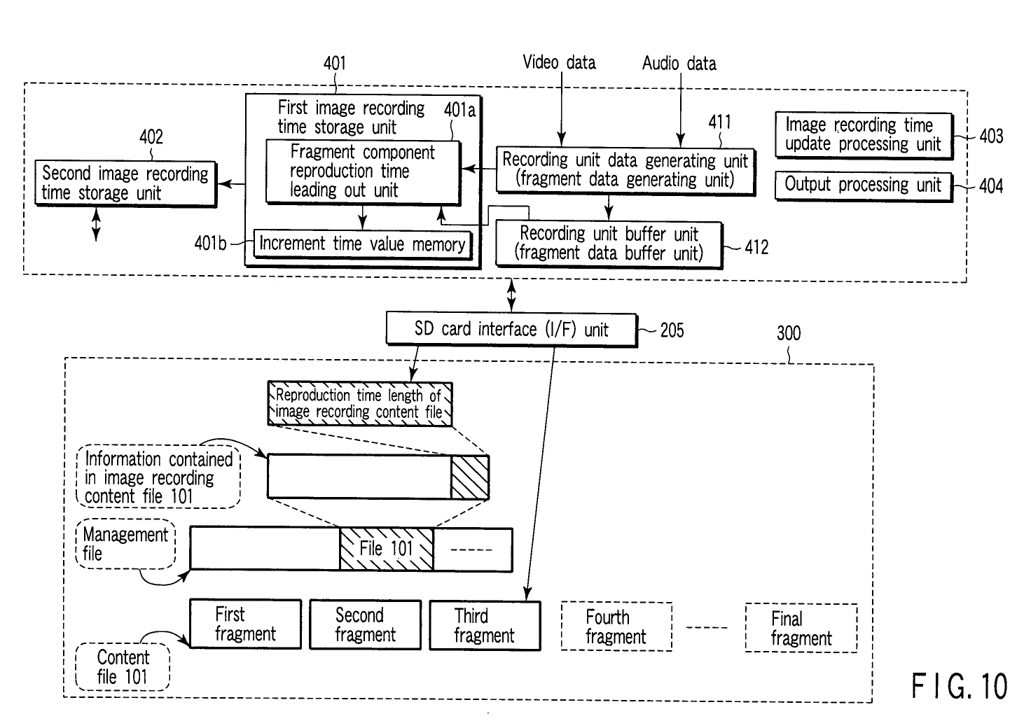

FIG. 10 shows a sample of functional blocks that operate when data is processed along the flow chart described above. The video data and audio data compressed in accordance with the MPEG-4 standard is inputted to a fragment data generating unit (previous recording unit data generating unit) 411. Then, fragment data is formed in accordance with an MP4 file standard, and then, the formed data is temporarily stored in a fragment data buffer unit (previous recording unit buffer unit) 412. The first image recording time storage unit 401 includes a fragment component reproduction time lead out unit 401a and an increment time value memory 401b. Every time single fragment data is produced, a value of a reproduction time is obtained, and this value is cumulatively added to a value accumulated in the increment time value memory 401b. Then, when data for a single file has been processed, the contents of the increment time value memory 401b are utilized for an individual image recording time. For example, the above contents are written into a predetermined filed of a management file as an image recording time length (reproduction time length) of a content file 101.

Here, data on a total reproduction time length recorded in advance in a management data file (shown in FIG. 3) is read and stored in the second image recording time storage unit 402. Then, every time a reproduction time for a single fragment that is a unit of recording is led out, data on a total reproduction time length is also updated, and then, the updated data is described in a predetermined field of an SD memory card.

As a result, in the case of an interruption if any error occurs in the course of image recording or in the case where recording has been interrupted partway due to a failure (such as operating error, battery power consumption, or power-down), the individual image recording time length and the total image recording time length immediately preceding the above case are reliably recorded in a predetermined field. Therefore, a problem such as inability to carry out subsequent editing or to create a play list is eliminated.

While certain embodiments of the inventions have been described, these embodiments have been presented by way of example only, and are not intended to limit the scope of the inventions. Indeed, the novel methods and systems described herein may be embodied in a variety of forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An information recording apparatus comprising:
a first image recording time storage unit for a single file which, when compressed/encoded contents are delimited in units of recording, are sequentially recorded in a recording medium, and are formed as a single file, sequentially accumulates an image recording time length in the units of recording, and then, calculates and stores an image recording time length for a single file;
a second image recording time storage unit which calculates and stores a total image recording time length of a plurality of files recorded in the recording medium;
an image recording time length update processing unit which updates the recorded image recording time length component of the units of recording every time small contents that are the units of recording are recorded in the recording medium, in addition to the image recording time length for the single file and the total image recording time length; and
a recording control unit which records in the recording medium, the image recording time length for the single file and the total image recording time length updated in each of the first and second image recording storage units every time the contents delimited in the units of recording have been recorded in the recording medium.

2. The information recording apparatus according to claim 1, wherein the recording medium is a memory card.

3. The information recording apparatus according to claim 1, wherein the units of recording of the small contents are units of segments of the recording medium.

4. The information recording apparatus according to claim 1, wherein the compressed/encoded contents are obtained from a recording/reproducing unit which carries out compression encoding/decoding in accordance with an MPEG-4 standard.

5. The information recording apparatus according to claim 1, wherein the compressed/encoded contents are data contained in a packet outputted from a TS-format recording/reproducing unit that handles a packet in a transport stream format.

6. A recorded information management method of an apparatus having a first image recording time storage unit for a single file which, when compressed/encoded contents are delimited in units of recording, are sequentially recorded in a recording medium, and are formed as a single file, sequentially accumulates an image recording time length in the units of recording, and then, calculates and stores an image recording time length for a single file; and a second image recording time storage unit which calculates and stores a total image recording time length of a plurality of files recorded in the recording medium, the method comprising:
updating the recorded image recording time length component of the units of recording every time small contents that are the units of recording are recorded in the recording medium, in addition to the image recording time length for the single file and the total image recording time length; and
recording in the recording medium, the image recording time length for the single file and the total image recording time length updated in each of the first and second image recording storage units every time the contents delimited in the units of recording have been recorded in the recording medium.

7. The recorded information management method according to claim 6, wherein the units of recording of the small contents are units of segments of the recording medium.

8. The recorded information management method according to claim 6, wherein the units of recording of the small contents are units of segments of the recording medium, and the compressed/encoded contents are data compressed and encoded/decoded in accordance with an MPEG-4 standard.

9. The recorded information management method according to claim 6, wherein the units of recording of the small contents are units of segments of the recording medium, the compressed/encoded contents are packets formed in a transport stream format, and a single segment is 32 packets.

10. The recorded information management method according to claim 6, wherein a total image recording time length before updated, that has been already recorded, is transferred in advance from the inside of a management data file of the recording medium to the second image recording time storage unit which calculates and stores a total image recording time length for a plurality of files, before starting a calculating operation.
